(19) United States
(12) Patent Application Publication
(10) Pub. No.: US 2010/0104187 A1
(43) Pub. Date: Apr. 29, 2010

(54) Personal navigation device and related method of adding tags to photos according to content of the photos and geographical information of where photos were taken

(76) Inventor: Matt Broadbent, Auckland (NZ)

Correspondence Address: NORTH AMERICA INTELLECTUAL PROPERTY CORPORATION, P.O. BOX 506, MERRIFIELD, VA, 22116, US

(21) Appl. No.: 12/257,391

(22) Filed: Oct. 24, 2008

(51) Int. Cl. G06F 17/30

(52) U.S. Cl. 382/176; 707/E17.004

(57) ABSTRACT

A method of automatically adding tags to photos based on content of the photos and geographical information about where the photo was taken includes taking a photo with a camera of a personal navigation device, generating a geographical tag for the photo with the personal navigation device and attaching the geographical tag to the photo to generate a geotagged photo, transferring the geotagged photo to an optical character recognition (OCR) server, performing OCR on the geotagged photo with the OCR server and generating image description tags from text recognized in the geotagged photo, attaching selected tags to the geotagged photo, the selected tags being selected from the generated image description tags, and uploading the geotagged photo along with the attached selected tags to a photo sharing server, photos on the server being searchable by geographical tags or selected tags associated with the photos.

### BACKGROUND OF THE INVENTION

1. Field of the Invention

The invention relates to a method of adding tags to a photo, and more particularly, to method of adding geotags to a photo along with tags generated from content of the photos.

2. Description of the Prior Art

In recent years, the popularity of sharing photos on the internet has grown dramatically. Adding tags to photos is a common way to allow others to quickly and easily search for photos that interest them. For example, a photo of two friends “Bob” and “Tom” celebrating Tom's birthday can be given the tags of “Bob”, “Tom”, “birthday”, and so on. Users are now adding tags to an increasingly larger amount of photos, and this trend is expected to continue in the foreseeable future.

Unfortunately, the process of adding tags to photos can be a laborious process, and this can result in users only adding minimal tags to a photo, decreasing the potential use of the tags. Therefore, a method for automatically generating tags for photos is needed.

### SUMMARY OF THE INVENTION

It is therefore one of the primary objectives of the claimed invention to provide a way to automatically generate tags for a photo based on the content of the photo and the location where the photo was taken.

According to an exemplary embodiment of the claimed invention, a method of automatically adding tags to photos based on content of the photos and geographical information is disclosed. The method includes taking a photo with a camera of a personal navigation device, generating a geographical tag for the photo with the personal navigation device and attaching the geographical tag to the photo to generate a geotagged photo, transferring the geotagged photo to an optical character recognition (OCR) server, performing OCR on the geotagged photo with the OCR server and generating image description tags on the OCR server from a text recognized in the geotagged photo, and utilizing the personal navigation device to select tags from the image description tags generated by the OCR server and attach the selected tags to the geotagged photo.

According to another exemplary embodiment of the claimed invention, a personal navigation device for automatically adding tags to photos based on content of the photos and geographical information is disclosed. The personal navigation device includes a camera for creating photos, generating a geographical tag for the photo, and attaching the geographical tag to the photo to generate a geotagged photo, a communication port for transmitting the geotagged photo to an optical character recognition (OCR) server and receiving image description tags generated by the OCR server resulting from the OCR server performing OCR on the geotagged photo to generate the image description tags from a text recognized in the geotagged photo, and a user interface for selecting tags from the image description tags generated by the OCR server and attach the selected tags to the geotagged photo.

It is an advantage that tags for the photos are automatically generated according to the content of the photos and the location of the subject of the photo. In this way, the additional tags generated can aid users in searching for photos of interest, thereby increasing the chance of the photo being seen by others.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a photo containing text that can be recognized through OCR technology.

FIG. 2 illustrates a system for automatically generating tags for photos according to the present invention.

FIG. 3 is a flowchart of the method of adding tags to photos according to the present invention method.

### DETAILED DESCRIPTION

The present invention makes use of optical character recognition (OCR) technology for recognizing text present in a photo for possible inclusion as tags of the photo. OCR technology is used analyzing digital images, recognizing text that is present in the digital images, and extracting the text in a usable format, such as in a text document. In addition, a geographical tag, or geotag, indicating the location at which the photo was taken is also added to the photo. Both of these forms of tags can be automatically generated, thereby saving users from having to add the tags manually.

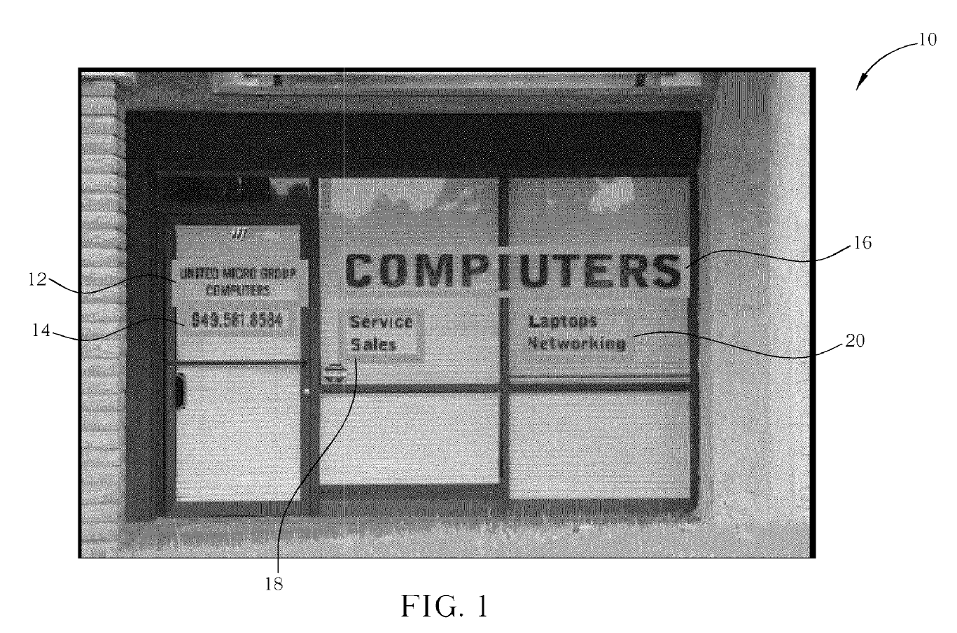

Please refer to FIG. 1. FIG. 1 is a photo 10 containing text that can be recognized through OCR technology. The photo 10 is taken of the front of a computer store, and shows several signs 12, 14, 16, 18, and 20 on the front of the computer store. In this case, all of the signs 12, 14, 16, 18, and 20 contain alphanumeric characters that can be recognized using common OCR technology. Sign 12 contains the name of the computer store, sign 14 contains the phone number of the computer store, sign 16 indicates the type of store being photographed, and signs 18 and 20 indicate services and products that the store offers. Each of these signs 12, 14, 16, 18, and 20 makes a good candidate for serving as a tag of the photo 10 since each describes some aspect of the store.

Suppose that the photo 10 is uploaded to a popular photo sharing website such as Flickr. If tags are created corresponding to signs 12, 14, 16, 18, and 20, users would be able to locate the photo 10 by searching for any of the keywords represented by these tags. In addition, by adding a geotag to the photo 10 giving precise information about where the photo 10 was taken, users searing for the photo 10 can know exactly where the computer store is located.

Recently, Global Positioning System (GPS) based personal navigation devices have been made that have built-in cameras. The personal navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means. The personal navigation devices can also be removed and taken with a user while the user is walking around. Since the personal navigation device having a built-in camera already contains a GPS receiver, geotags can be added to photos that the personal navigation device takes.

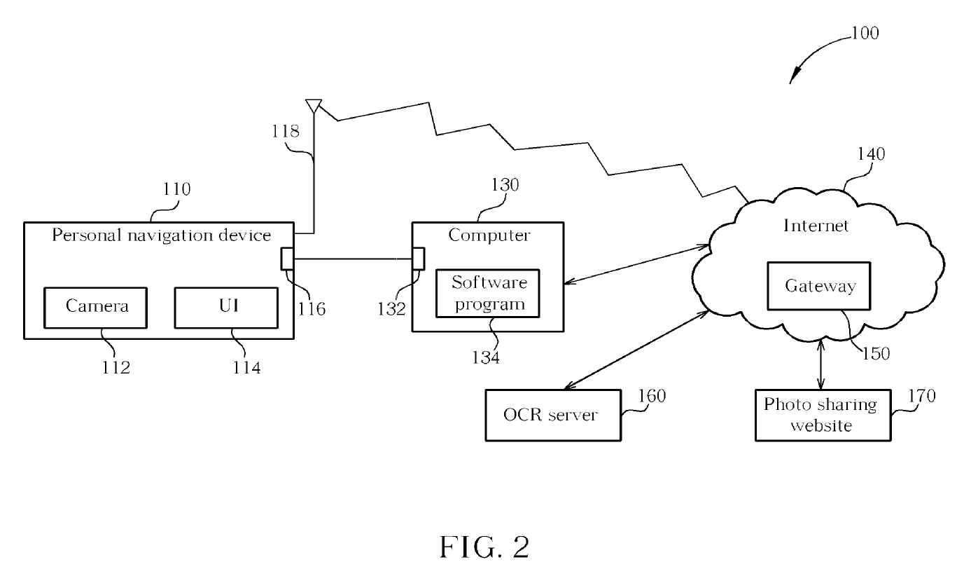

Please refer to FIG. 2. FIG. 2 illustrates a system 100 for automatically generating tags for photos according to the present invention. The system 100 contains a personal navigation device 110 having a built-in camera 112. The camera 112 can be used for taking photos such as the photo 10 shown in FIG. 1. At this time, the personal navigation device 110 can add geotag coordinates to the photo 10 for identifying the location where the photo 10 was taken. After this, the personal navigation device 110 transfers the photo 10 to a gateway 150 via the internet 140.

There are two preferred ways of transferring the photo 10 from the personal navigation device 110 to the gateway 150. The first preferred way involves connecting the personal navigation device 110 to a computer 130 using communication ports 116 and 132 located on the personal navigation device 110 and the computer 130, respectively. The computer 130 has a software program 134 installed on it for communicating with the personal navigation device 110 and retrieving the photo 10 from the personal navigation device 110. The computer 130 can then transfer the photo 10 to the gateway 150 via the internet 140.

The second preferred way of transferring the photo 10 to the gateway 150 involves wirelessly transmitting the photo 10 from the personal navigation device 110 using wireless transmission technology such as one of the IEEE 802.11x standards. In this case, the personal navigation device 110 would include an antenna 118 for wirelessly transmitting and receiving data. A user interface 114 of the personal navigation device 110 can be used for selecting the photo 10 that will be transmitted to the gateway 150.

In either case, once the gateway 150 has received the photo 10, the gateway 150 sends the photo 10 to an OCR server 160. The OCR server 160 performs an OCR process on the photo 10 using existing prior art OCR methods in order to recognize text present in the signs 12, 14, 16, 18, and 20 of the photo 10. The OCR server 160 then sends the recognized text back to the gateway 150.

In the first case above where the personal navigation device 110 connects to the gateway 150 through the computer 130, the gateway 150 will send the recognized text back to the computer 130. At this point, the user of the computer 130 has the chance to edit, add, or delete text strings that were recognized by the OCR server 160 using the software program 134. Once the user has finished deciding what text strings he would like to associate with the photo 10, the text strings are saved and attached to the photo 10 as tags of the photo 10. Thus, since a geotag was added to the photo 10 previously, the photo 10 now contains both the geotag as well as the tags created according to the content of the photo 10 using OCR. The tagged photo 10 can now be shared with others to allow others to search for the photo 10 using the tags. To do this, the user can control the software program 134 of the computer 130 to upload the photo 10 to a photo sharing website 170 via the gateway 150. The photo 10 can also be stored on a photo server instead of or in addition to the photo sharing website 170.

In the second case above where the personal navigation device 110 connects to the gateway 150 through wireless transmission, the gateway 150 will send the recognized text back to the personal navigation device 110 directly through the antenna 118. At this point, the user of the personal navigation device 110 has the chance to edit, add, or delete text strings that were recognized by the OCR server 160 using the user interface 114. Once the user has finished deciding what text strings he would like to associate with the photo 10, the text strings are saved and attached to the photo 10 as tags of the photo 10. Thus, since a geotag was added to the photo 10 previously, the photo 10 now contains both the geotag as well as the tags created according to the content of the photo 10 using OCR. The tagged photo 10 can now be shared with others to allow others to search for the photo 10 using the tags. To do this, the user can control the user interface 114 to upload the photo 10 to the photo sharing website 170 via the gateway 150.

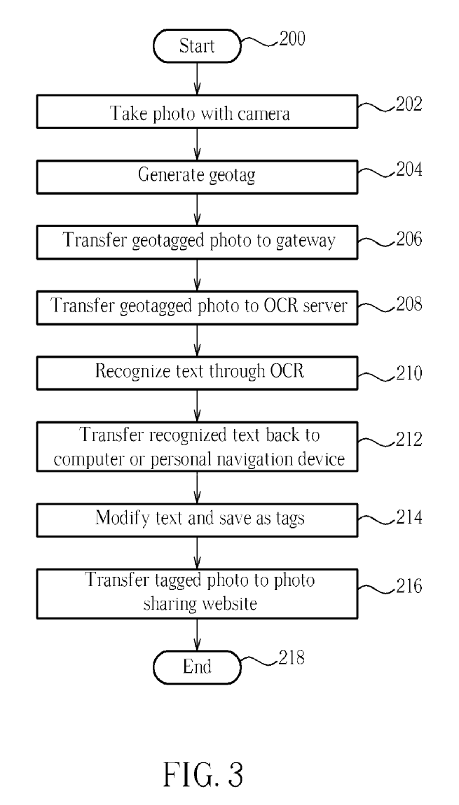

Please refer to FIG. 3. FIG. 3 is a flowchart of the method of adding tags to photos according to the present invention method. The method starts in step 200, and the camera 112 of the personal navigation device 110 is used to take the photo 10 in step 202. Then in step 204 the personal navigation device 110 adds a geotag to the photo 10. The geotagged photo 10 is then sent to the gateway 150 in step 206 either via the computer 130 or directly through wireless transmission. In step 208, the gateway 150 transfers the geotagged photo 10 to the OCR server 160, and the OCR server 160 performs OCR on the photo 10 in step 210 to generate recognized text from the photo 10. The generated text is then sent back to either the computer 130 or the personal navigation device 110 in step 212, where the user has the chance to edit, add, or delete text in step 214. Once the user has finished modifying the text, the text is saved as tags of the photo 10, and the photo 10 along with the geotag and the newly saved tags are uploaded to the photo sharing website 170 via the gateway 150 in step 216. The method then concludes in step 218.

In addition to automatically generating text tags using OCR, other tags can also be created based on analysis of the photo 10, such as tags describing the predominant color of the photo 10 or the texture of the photo 10. Prior art methods can be used to analyze the photo 10 and determine aesthetic aspects of the photo 10 such as the predominant color of the photo. These aesthetic aspects can then be indicated through text tags that are later added to the photo 10. In addition, tags can also be created that advertise certain products, such as the brand of the personal navigation device 110 used to take the photo 10. In these advertisements, a uniform resource locator (URL) of a company can also be included since users viewing the photos are most likely already viewing them through the internet 140.

Furthermore, the geotag is not limited to only providing the latitude and longitude coordinates about where the photo 10 was taken. The time and date of when the photo 10 was taken can also be included. The user can also tag a series of photos using a common tag indicating the itinerary or destination information of a trip during which the photo 10 was taken. For instance, a series of photos can be labeled as “Route 66” or “Trip to Grand Canyon” or other such label.

In summary, the present invention provides a quick and easy way to create tags for photos by automatically generating tags using geotagging and OCR technology. The ability to share these tagged photos online will allow photo sharing websites to grow more quickly, while at the same time increasing the usefulness of tag searches made through the websites.

Those skilled in the art will readily observe that numerous modifications and alterations of the device and method may be made while retaining the teachings of the invention.

What is claimed is:

1. A method of automatically adding tags to photos based on content of the photos and geographical information, the method comprising:
taking a photo with a camera of a personal navigation device;
generating a geographical tag for the photo with the personal navigation device and attaching the geographical tag to the photo to generate a geotagged photo;
transferring the geotagged photo to an optical character recognition (OCR) server;
performing OCR on the geotagged photo with the OCR server and generating image description tags on the OCR server from a text recognized in the geotagged photo; and
utilizing the personal navigation device to select tags from the image description tags generated by the OCR server and attach the selected tags to the geotagged photo.

2. The method of claim 1, wherein the geographical tag includes latitude and longitude coordinates of a location where the geotagged photo was taken.

3. The method of claim 1, wherein the geographical tag includes a time and date of when the geotagged photo was taken.

4. The method of claim 1, wherein the geographical tag includes information describing itinerary or destination information of a trip during which the geotagged photo was taken.

5. The method of claim 1 further comprising editing image description tags before selecting the selected tags and attaching the selected tags to the geotagged photo.

6. The method of claim 1 further comprising uploading the geotagged photo along with the attached selected tags from the personal navigation device to a photo sharing server, photos on the server being searchable by geographical tags or selected tags associated with the photos.

7. The method of claim 6 further comprising attaching an advertising tag to the geotagged photo before the geotagged photo is uploaded to the photo sharing server.

8. The method of claim 6 further comprising utilizing a gateway to facilitate communication between the personal navigation device, the OCR server, and the photo sharing server.

9. The method of claim 8, wherein the personal navigation device utilizes a wireless internet connection to communicate with the gateway via the internet.

10. The method of claim 8 further comprising connecting the personal navigation device to a computer for transferring data to and from the computer, the computer communicating with the gateway via the internet.

11. A personal navigation device for automatically adding tags to photos based on content of the photos and geographical information, the personal navigation device comprising:
a camera for creating photos, generating a geographical tag for the photo, and attaching the geographical tag to the photo to generate a geotagged photo;
a communication port for transmitting the geotagged photo to an optical character recognition (OCR) server and receiving image description tags generated by the OCR server resulting from the OCR server performing OCR on the geotagged photo to generate the image description tags from a text recognized in the geotagged photo; and
a user interface for selecting tags from the image description tags generated by the OCR server and attach the selected tags to the geotagged photo.

12. The personal navigation device of claim 11, wherein the geographical tag includes latitude and longitude coordinates of a location where the geotagged photo was taken.

13. The personal navigation device of claim 11, wherein the geographical tag includes a time and date of when the geotagged photo was taken.

14. The personal navigation device of claim 11, wherein the geographical tag includes information describing itinerary or destination information of a trip during which the geotagged photo was taken.

15. The personal navigation device of claim 11, wherein the user interface allows a user to edit image description tags before selecting the selected tags and attaching the selected tags to the geotagged photo.

16. The personal navigation device of claim 11, wherein the user interface allows a user to upload the geotagged photo along with the attached selected tags from the personal navigation device to a photo sharing server via the communication port, photos on the server being searchable by geographical tags or selected tags associated with the photos.

17. The personal navigation device of claim 16, wherein an advertising tag is attached to the geotagged photo before the geotagged photo is stored in the photo sharing server.

18. The personal navigation device of claim 16 further comprising a gateway connected to the personal navigation device, the OCR server, and the photo sharing server via the internet for facilitating communication between the personal navigation device, the OCR server, and the photo sharing server.

19. The personal navigation device of claim 18, wherein the personal navigation device utilizes a wireless internet connection to communicate with the gateway via the internet.

20. The personal navigation device of claim 18 further comprising a computer for connecting to the personal navigation device and transferring data to and from the personal navigation device, the computer communicating with the gateway via the internet.
